(19) United States
(12) Patent Application Publication
(10) Pub. No.: US 2019/0377935 A1
(43) Pub. Date: Dec. 12, 2019

(54) METHOD AND APPARATUS FOR TRACKING FEATURES

(71) Applicant: CUBIC MOTION LIMITED, Manchester (GB)

(72) Inventor: Gareth Edwards, Cheshire (GB)

(73) Assignee: CUBIC MOTION LIMITED, Manchester (GB)

(21) Appl. No.: 16/488,024

(22) PCT Filed: Feb. 16, 2018
(86) PCT No.: PCT/GB2018/050416

§ 371 Date: Aug. 22, 2019

(30) Foreign Application Priority Data
Feb. 22, 2017 (GB) 1702864.8

(51) Int. Cl. G06K 9/00; G06K 9/62

(52) U.S. Cl. CPC G06K 9/00281; G06K 9/6209; G06K 9/6256

(57) ABSTRACT

Embodiments of the present invention provide a systems and methods for tracking features. In particular, some aspects of the present invention relate to a method and system for facial modelling and a method and system for determining facial features. Embodiments of the invention comprise receiving stereo image data comprising a set of corresponding first and second stereo-rectified image frames indicative of a target; annotating the stereo image data to determine a location of an image feature in the first and second stereo-rectified image frames, wherein the determined locations in the first and second corresponding stereo-rectified image frames are positionally constrained according to an epipolar constraint; and training a shape variation model corresponding to the target according to the determined image feature locations.

### TECHNICAL FIELD

Aspects of the invention relate to a method and system for tracking features. In particular, some aspects of the present invention relate to a method and system for facial modelling and a method and system for determining facial features.

### BACKGROUND

Virtual and augmented reality technologies provide a computer-generated simulation of an image or environment that can be experienced and interacted with by a user. Special electronic equipment may be used, such as a virtual reality (VR) or augmented reality (AR) headset or other similar peripherals.

Applications of VR/AR technology include use in entertainment and social media, such as when a user is presented with graphics that represent human or humanoid forms, such as digital characters or avatars. In some cases, it is desirable to capture and represent the appearance and/or movement of the user wearing the device in the virtual or augmented world. For example, it may be desirable to capture a digital representation of a user in order to facilitate a conversation or conversational interactions between multiple users in virtual space. Facial expressions are an example of an important user movement that can be used to convey communication in VR/AR. However it is difficult to capture such facial expressions or facial movements in real-time whilst the user is wearing a headset.

It is an object of embodiments of the invention to at least mitigate one or more of the problems of the prior art.

### SUMMARY OF THE INVENTION

Aspects and embodiments of the invention provide methods, systems, and computer software as claimed in the appended claims.

According to an aspect of the invention, there is provided a method of modelling. In an embodiment of the invention, the method may relate to facial modelling. The method may comprise receiving stereo image data comprising a set of corresponding first and second image frames indicative of a target. The received image frames may be stereo-rectified. Advantageously, receiving stereo-rectified image frames allows the correspondence problem to be simplified such that searching for corresponding points in both frames can be simplified to one dimension, e.g. the horizontal dimension. The method may comprise annotating the stereo image data to determine a location of an image feature in the first and second stereo image frames. The determined locations in the first and second corresponding stereo-rectified image frames may be positionally constrained according to an epipolar constraint. Advantageously, the epipolar constraint improves the reliability and robustness of tracking algorithms. The method may comprise training a shape variation model corresponding to the target according to the determined image feature locations.

In an embodiment of the invention, the method may further comprise receiving stereo image data comprising a set of first and second stereo-rectified image frames indicative of a target and processing the stereo image test data, wherein the processing comprises using the shape variation model to determine parameters associated with at least one image feature identified in the stereo image data.

In an embodiment of the invention, determining the location of an image feature may comprise marking a first point location of the image feature in the first image frame and marking a second corresponding point location of the image feature in the second frame.

In an embodiment of the invention, the shape variation model may be trained to map a fixed vector of point locations, X, to a vector of model parameters, p.

In an embodiment of the invention, the fixed vector of point locations, X, may be indicative of determined locations of the image feature.

According to an aspect of the invention, there is provided a method of determining features. In an embodiment of the invention, the method may relate to determining facial features. The method may comprise receiving stereo image data comprising a set of corresponding first and second image frames indicative of a target. The first and second image frames may be stereo-rectified. Advantageously, receiving stereo-rectified image frames allows the correspondence problem to be simplified such that searching for corresponding points in both frames can be simplified to one dimension, e.g. the horizontal dimension. The method may comprise processing the stereo image data, wherein the processing comprises using a shape variation model to determine parameters associated with at least one image feature, X, identified in the stereo image data.

According to an embodiment of the invention, the identified image feature, X, may comprise a fixed vector of point locations indicative of the image feature.

According to an embodiment of the invention, the processing may comprise using the shape variation model to estimate a vector, p, of model parameters according to the identified image feature, X.

According to an embodiment of the invention, determining parameters associated with the at least one image feature may comprise using the shape variation model to estimate at least one point location, X′, indicative of the image feature, given the vector of model parameters, p.

In an embodiment of the invention, the shape variation model may be a Linear Point Distribution Model. Advantageously, using a Linear Point Distribution Model allows for efficient and fast model parameter calculation.

In an embodiment of the invention, the features identified in the stereo image data may correspond to image features determined for training the shape variation model.

In an embodiment of the invention, the features identified in the stereo image data are identified using a profile matching algorithm. Optionally, the profile matching algorithm may use an Active Shape Model. Optionally, the profile matching algorithm may comprise tracking local patches in a regression framework.

According to an aspect of the invention, there is provided a system for modelling. In an embodiment of the invention, the system may relate to facial modelling. The system may comprise an input means for receiving stereo image data comprising a set of first and second image frames indicative of a target. The first and second image frames may be stereo-rectified. The system may comprise an annotating means for determining a location of an image feature in the first and second stereo-rectified image frames. The determined locations in the first and second stereo-rectified image frames may be positionally constrained according to an epipolar constraint. The system may comprise a training means for training a shape variation model according to the determined image feature locations.

In an embodiment of the invention, the system further comprises a secondary input means for receiving stereo image data comprising a set of corresponding first and second stereo-rectified image frames indicative of a target, a secondary processing means for using the shape variation model to determine parameters associated with at least one image feature identified in the stereo image data, and output means for outputting the parameters associated with the at least one image feature.

According to an aspect of the invention, there is provided a system for determining features. In an embodiment of the invention, the system may relate to determining facial features. The system comprises input means for receiving stereo image data comprising a set of corresponding first and second image frames indicative of a target. The first and second image frames may be stereo-rectified. The system comprises processing means for using a stored shape variation model to determine parameters associated with at least one image feature identified in the stereo image data. The system comprises output means for outputting the parameters associated with the at least one image feature.

The processing means may comprise one or more electronic processing devices which operable execute a set of instructions. The set of instructions may be stored in one or more memory devices accessible to the one or more processing devices. The set of instructions may implement one or both of the annotating means and the training means. The input means may comprise an electrical input for receiving the stereo image data.

In an embodiment of the invention, the input means may comprise a stereo camera. Optionally, the stereo camera is attachable to a headset. Advantageously, this allows for operation in combination with the VR/AR headset. The stereo image camera may output the stereo image data to the one or more processing devices.

In an embodiment of the invention, the stereo camera is an infra-red camera. Advantageously, this allows for operation in sub-optimal light conditions.

In an embodiment of the invention, the shape variation model is trained according to a training dataset. Optionally, the training dataset is constrained according to an epipolar constraint.

In an embodiment of the invention, the shape variation model is a Linear Point Distribution Model.

In an embodiment of the invention, identifying the at least one image feature in the stereo image data may comprise using a profile matching algorithm. Optionally, the profile matching algorithm may use an Active Shape Model. Optionally, the profile matching algorithm may comprise tracking local patches in a regression framework.

In an embodiment of the invention, the output means may comprise an output device.

The output device may be a graphical display.

According to an aspect of the invention, there is provided computer software which, when executed by a processor, configures the processor to perform any of the methods described above.

According to an aspect of the invention, there is provided a computer readable storage medium comprising the computer software as described above. The computer software may be tangibly stored on the computer readable medium. The computer readable medium may be non-transitory.

Within the scope of this application it is expressly intended that the various aspects, embodiments, examples, and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIG. 1 shows a system according to an embodiment of the invention;

FIG. 2 shows an example of stereo image data according to an embodiment of the invention;

FIG. 3 shows an example of annotated data according to an embodiment of the invention;

FIG. 4 shows a method according to an embodiment of the invention;

FIG. 5 shows a system according to an embodiment of the invention;

FIG. 6 shows a method according to an embodiment of the invention;

FIG. 7 shows an apparatus according to an embodiment of the invention; and

FIG. 8 shows an apparatus according to an embodiment of the invention.

### DETAILED DESCRIPTION

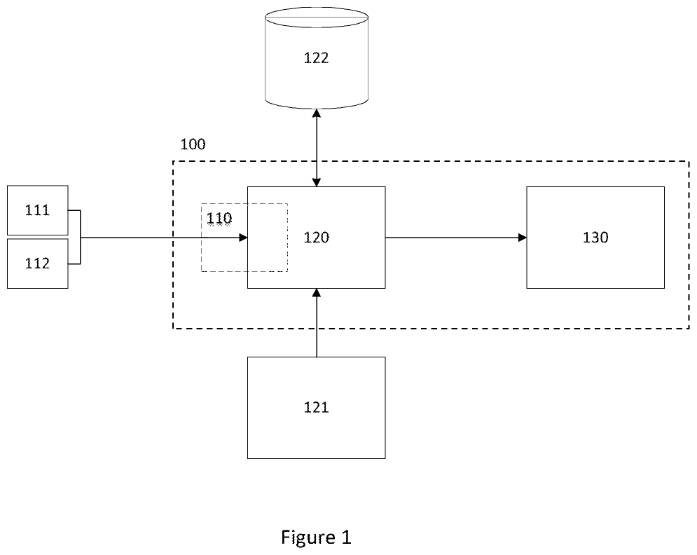

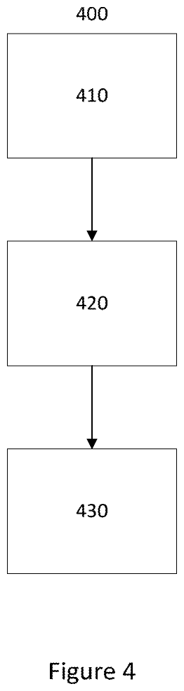

An embodiment of the invention provides a system 100 for facial modelling, as shown in FIG. 1. Although not specifically shown in FIG. 1, the system 100 may comprise one or more processing devices, such as a processors and a memory for operably storing data therein which may comprise software executable by the one or more processors. The system 100 may be formed by a computer or computing apparatus 100. The system 100 may comprise an input means 110 for receiving stereo image data comprising a set of corresponding first and second stereo-rectified image frames indicative of a target, annotating means 120 for determining a location of an image feature in the stereo image data, and processing means 130 for training a shape variation model according to the determined location of the image feature 130. The system 100 may be used to implement a method for modelling 400, such as that shown in FIG. 4.

The input means 110 for receiving stereo image data may comprise an interface for receiving data from a stereo camera, two (or more) individual or ordinary cameras 111, 112 mounted in a fixed positional relationship, such as side-by-side (which may include a predetermined spacing between the cameras), or any suitable image capture means for providing stereo image data comprising a first and a second image frame of the target, such as at least a portion of a person's face. In some embodiments, the stereo image data may be received from a training dataset. In operation, image data comprising a large number of different targets, e.g. faces, may be used in order to improve a robustness of the determined shape variation model. In some embodiments, the input means 110 is arranged to receive a plurality of image frames in succession, i.e. a video stream. In some embodiments, the input means 110 may receive infra-red illuminated image data. Advantageously, using infra-red illumination allows for operation in sub-optimal light conditions.

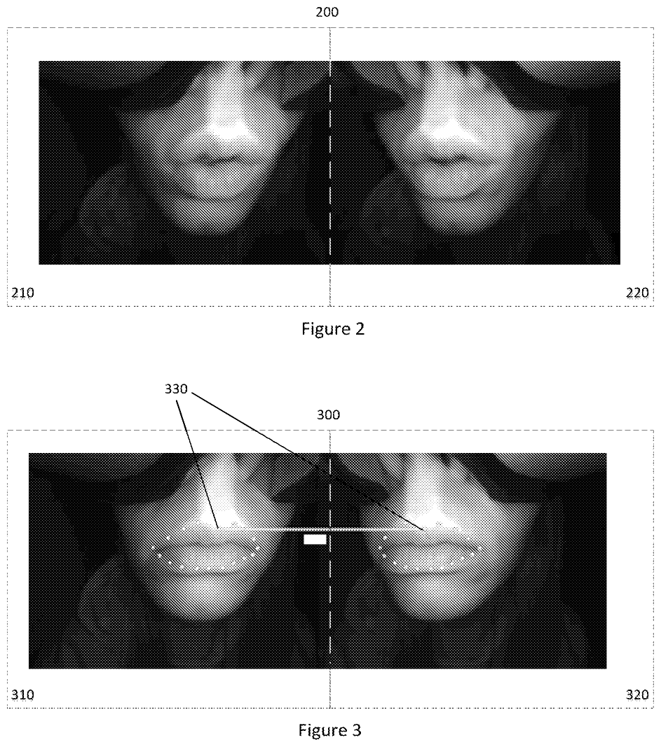

An example of the stereo image data 200 is shown in FIG. 2, which comprises first 210 and second 220 stereo image frames. The first and second image frames 210, 220 may be indicative of views of the target from left and right perspectives respectively, for example. The use of stereo image data, such as 200, allows the capture of depth information via calculations based on epipolar geometry, as will be explained. The input means 110 is arranged to receive the first and second image frames 210, 220 in stereo-rectified form, such that a feature of an image appears in the same location along a common axis in both the first and second image frames 210, 220. For example, the stereo camera may be associated with a transform unit for transforming the first and second image frames such that a real-world feature in both of the image frames 210, 220 (for example a corner of a mouth) appears in the same location in both frames along a vertical axis. In other embodiments, the stereo-rectifying transform may be applied by a transform module (not specifically shown) which is comprised in the system 100. The transform module is arranged to receive image data from first and second cameras and to output the stereo image data to the input means as the first and second image frames 210, 220.

The system 100 comprises an annotating means 120. The annotating means 120 may comprise at least one or more processing devices arranged to determine a location of an image feature in the first and second stereo-rectified image frames 210, 220. In such embodiments, the annotating means 120 may comprise an annotating module arranged to receive the stereo image data, which is communicative with a suitable display and input means 121, such as one or more input devices for a user to input an indication of the determined location of the image feature. The annotating module 120 may operatively execute on the one or more processors of the system 100. In other embodiments, the annotating means 120 may be external to the system 100. The system 100 may be associated with an accessible storage device 122 for storage of the locations of the image features. The storage device 122 may be external to the system 100, as shown in FIG. 1, or internal to the system 100 such as the memory of the system 100.

An example of an annotated stereo image data 300 is shown in FIG. 3. The first and second image frames 310, 320 may be indicative of views of the target from left and right perspectives respectively, for example. Locations of image features have been marked in the illustrated frames 310, 320 comprising a first point location of the image feature in the first image frame and marking a second corresponding point location of the image feature in the second image frame, e.g. 330. The location 330 of the image feature in the first and second image frames has also been constrained according to an epipolar constraint 340, such that such that a position along one axis of the first and second locations is the same.

The system 100 comprises a training means 130 for training a shape variation model according to the determined image feature locations, as will be explained. The training means 130 may comprise a training module which is arranged to receive the determined locations of the image features in the stereo image data and to train a shape variation model accordingly. In an embodiment of the invention, the shape variation model may correspond to a face, however it will be appreciated that other shapes may be envisaged appropriate for the target. The shape variation model may be stored in the memory of the system 100.

An embodiment of the invention provides a method 400 of generating a model, such as for facial modelling, as shown in FIG. 4. The method 400 may be referred to as a training method, and is arranged to provide a trained shape variation model which may be used to determine facial features during a corresponding run-time method. In operation, facial modelling may be performed using a training dataset of one or more than one, possibly many people. The method 400 may be used with the system 100 illustrated in FIG. 1.

The method 400 comprises a step 410 of receiving stereo image data comprising a set of corresponding first and second stereo-rectified image frames 210, 220 indicative of at least one face. In an embodiment of the invention, the stereo image data may be received by an input means 110. The stereo image data received in step 410 may be from a training dataset. In operation, image data comprising a large number of different faces may be used in order to improve a robustness of a determined shape variation model.

The stereo image data received in step 410 may be may be received by the input means 110 comprising suitable apparatus such as a stereo camera, two (or more) individual or ordinary cameras 111, 112 mounted in a fixed positional relationship, such as side-by-side (which may include a predetermined spacing between the cameras), or any suitable image capture means for providing stereo image data comprising a first and second image frames of a target, such as at least a portion of a person's face.

In an embodiment of the invention, the first and second image frames 210, 220 may be indicative of views of the target from left and right perspectives respectively, for example. The first and second image frames 210, 220 are provided in stereo-rectified form, such that a feature of an image appears in the same location along a common axis in both the first and second image frames 210, 220. By aligning the first and second image frame perspectives to be coplanar via stereo-rectification, the correspondence problem is simplified such that searching for corresponding points in both frames can be simplified to one dimension, e.g. the horizontal dimension.

The method 400 comprises a step 420 of annotating the stereo image data to determine a location of an image feature in the first and second stereo-rectified image frames 210, 220. In an embodiment of the invention, the step 420 may be performed via an annotating means 120. In an embodiment of the invention, determining the location of the image feature may be performed manually, e.g. by a human operator. Determining the location of the image feature may comprise marking a first point location of the image feature in the first image frame 210 and marking a second corresponding point location of the image feature in the second image frame 220. In an embodiment of the invention, the step of determining the locations of the image feature in the first and second stereo-rectified image frames 210, 220 is constrained according to an epipolar constraint, such that a position along one axis of the first and second locations are equal.

The image feature may be a common physical feature in all of the frames of the stereo image data, and may be identified prior to annotating. Multiple image features may be annotated in each frame and multiple locations associated with each image feature may be determined, as shown in FIG. 3. As an example, image features such as the corner of a mouth, the top of a lip, etc. may be used, although it will be appreciated that other image features may be used. Determining the location of an image feature may comprise marking a first point location of the image feature in the first image frame 310, and marking a second corresponding point location of the image feature in the second image frame 320. In operation multiple point locations may be marked. In embodiments where the first and second image frames 310, 320 are indicative of views of a target face from left and right perspectives, annotating comprises marking the point location of an image feature in the left image frame 310, and marking the corresponding point location in the right image frame 320. The determined locations in the first and second image frames 310, 320 may further be constrained according to an epipolar constraint 330. For example, the locations may be constrained such that a position along one axis of the first and second point locations are the same. In operation, the constraining of determined locations may be imposed in software by restricting the ability to move the vertical position of the first and second point locations with respect to each other.

The method 400 further comprises a step 430 of training a shape variation model according to the annotated stereo image data. In an embodiment of the invention, the step 430 of training of a shape variation model may be performed via a processing means 130. In an embodiment of the invention, the shape variation model may comprise a stereo model, i.e. two-view model, corresponding to the stereo image data. The shape variation model may be indicative of the variable positions in which the point locations are distributed among training data. In some embodiments, the shape variation model may be Linear Point Distribution Model (PDM) of the annotated set of points. In general, the shape variation model can be any function, F, mapping a fixed vector of point locations X={X1, Y1, . . . Xn, Yn} to a vector of model parameters p, i.e. p=F(X). The shape variation model also provides a method for analytically or numerically estimating a shape X′ given a parameter vector p. Using a Linear Point Distribution Model advantageously allows for quick parameter calculation, however it will be appreciated that other non-linear variants of PDM may be used. In operation, if {Xi, Yi} and {Xj, Yj} are the coordinate locations of corresponding point locations 330 in a first and second image frame 310, 320, then the training data is constrained such that for every X, Yi==Yj. By using this constraint, any method for reconstructing X′ from a parameter vector p will yield a set of points in which Yi is equal to Yj. Advantageously, this removes the requirement for pose-aligning the training dataset, as the positions of the cameras providing the stereo image data are always fixed.

In an embodiment of the invention, the method 400 may comprise a method for tracking individual image features corresponding to the annotations. Tracking individual image features may comprise using profile matching, such as via an Active Shape Model algorithm, and may be performed via a processing means 130. In other embodiments, local patches may be tracked in a regression framework. For example, mini Active Appearance Models may be built for each local region around the image features. Alternatively, an Active Appearance Model may be trained for the entire shape and appearance of image features in the first and second image frames 210, 220.

By constraining the stereo image data according to an epipolar constraint during the training phase, the shape of the model is always restricted such that points along the vertical axis are always in the same position for first and second image frames 210, 220. Advantageously this improves the effectiveness and robustness of the tracking algorithms used, and allows for quicker tracking of the image features.

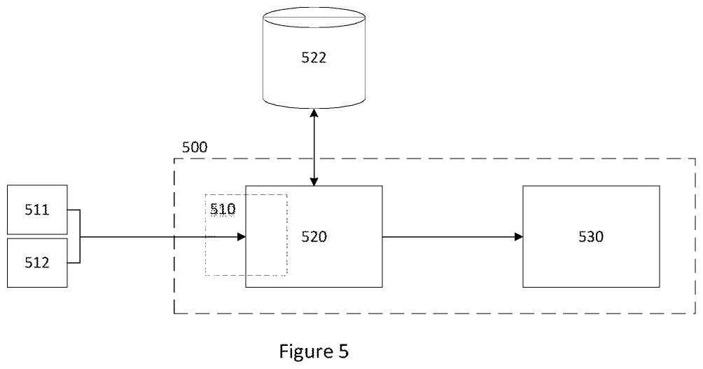

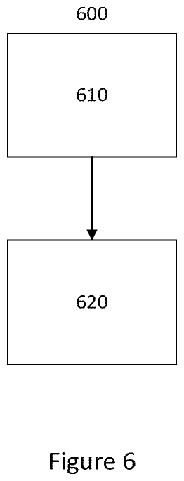

An embodiment of the invention provides a system 500 for determining features, as shown in FIG. 5. Although not specifically shown, the system 500 may comprise one or more processing devices, such as processors and a memory for operably storing data therein which may comprise software executable by the one or more processors. The system 500 may be formed by a computer or computing apparatus 500. The system 500 may be associated with a run-time system of the invention. The system 500 may be arranged to comprise an input means 510 for receiving stereo image data comprising a set of corresponding first and second stereo-rectified image frames indicative of a target, a processing means 520 for using a shape variation model to determine parameters associated with at least one image feature identified in the stereo image data, and an output means for outputting the parameters associated with the at least one image feature. The system 500 may be used to implement a method for determining facial features, as is illustrated in FIG. 6.

The input means 510 for receiving stereo image data may comprise an interface for receiving from a stereo camera, two (or more) individual or ordinary cameras 511, 512, or any suitable image capture means for providing stereo image data comprising a first and a second image frame of a target, such as at least a portion of a person's face. In some embodiments, the secondary input means 510 is arranged to receive a plurality of image frames in succession, i.e. a video stream. In some embodiments, the secondary input means 510 may receive infra-red illuminated image data. Advantageously, using infra-red illumination allows for operation in sub-optimal light conditions. In some embodiments, the secondary input means 510 is integrated into the stereo camera. In some embodiments, the input means 510 is attachable to a VR/AR device, such as a headset, for ease of use during real-time VR/AR operation. In some embodiments, the input means 510 may be integrated into the VR/AR device.

In an embodiment of the invention, the processing means 520 may comprise one or more processing devices arranged to use a shape variation model to determine parameters associated with at least one image feature identified in the stereo image data. The shape variation model may be stored on a storage device 522 accessible to the processing means 520.

The output means 530 may comprise a graphical display on which the parameters associated with the at least one image feature identified in the stereo image data may be output. Alternatively, in some embodiments, the parameters associated with at least one image feature identified in the stereo image data may be output to another processing means for further processing, such as an animation system for rendering a digital character or avatar.

According to an embodiment of the invention, there is provided a method 600 for determining facial features. The method 600 may be referred to as a run-time method, and is arranged to determine facial features according to a trained shape variation model. The method 600 may be used with the system 500 illustrated in FIG. 5.

The method 600 comprises a step 610 of receiving stereo image data comprising a set of corresponding first and second stereo-rectified image frames 210, 220 indicative of a target face. The stereo image data used in step 610 may be may be received from suitable apparatus such as a stereo camera, two (or more) individual or ordinary cameras mounted in a fixed positional relationship 511, 512, such as side-by-side (which may include a predetermined spacing between the cameras), or any suitable image capture means for providing stereo image data comprising a first and second image frames of a target, such as at least a portion of a person's face. The first and second image frames 210, 220 may be indicative of views of the target face from left and right perspectives respectively, for example. The first and second image frames are provided in stereo-rectified form, such that a feature of an image appears in the same location along a common axis in both the first and second image frames. For example, a transform may be applied to the first and second image frames such that a real-world feature (for example a corner of a mouth) appears in the same location along a vertical axis. In some embodiments the stereo-rectifying transform is applied by a transform unit associated with the stereo camera. In other embodiments, the stereo-rectifying transform may be applied by an associated module as part of the system 100. By aligning the first and second image frame perspectives to be coplanar, the correspondence problem is simplified such that searching for corresponding points in both frames can be simplified to one dimension, e.g. the horizontal dimension.

In an embodiment of the invention, the method 600 comprises a step of processing the stereo image data such that a shape variation model is used to determine parameters associated with at least one image feature identified or tracked in the stereo image data 620. In an embodiment of the invention, the features identified in the stereo image data may correspond to image features determined for training the shape variation model. For example, the shape variation model may be trained from a dataset comprising point locations indicative of a corner of a mouth, or the top of a lip. The image features tracked in the stereo image data may thus also correspond to a corner of a mouth, or the top of a lip. Identifying or tracking image features may comprise identifying at least one point location, X, indicative of the image feature. In some embodiments, a vector of point locations, X, indicative of the image feature may be identified. It will be appreciated that the tracking of image features in the received stereo image data may be performed by any suitable tracking algorithm. For example, the tracking may comprise using profile matching, such as via an Active Shape Model algorithm. In other embodiments, local patches may be tracked in a regression framework. For example, mini Active Appearance Models may be built for each local region around the image features. Alternatively, an Active Appearance Model may be trained for the entire shape and appearance of image features in the first and second image frames. A common image feature may be tracked in the first and second image frames 210, 220.

In an embodiment of the invention, during processing the tracked points indicative of the image feature are shape-constrained according to the shape variation model provided during a training phase. In an embodiment of the invention, processing the stereo image data may comprise using the shape variation model to constrain the possible relative locations of the tracked points associated with at least one image feature identified in each stereo image. In operation, the image features may be shape constrained by finding an optimal set of model parameters, p, to best fit the shape variation model to the tracked image feature points X. The shape constraint may constrain the points to an epipolar constraint, such as in 330, such that corresponding points of an image feature in the first and second image frames 210, 220 occur in the same location along a common axis. Using the optimal set of model parameters, p, the image feature can be reconstructed according to the shape variation model and parameters associated with the image feature, X′, can be determined. In an embodiment of the invention, the determined parameters associated with the image feature, X′, may be point locations indicative of the image feature. As an example of the invention, a vector of tracked point locations, X′, feature may be reconstructed from an identified vector of point locations indicative of an image feature in the stereo image data, X, according to the shape variation model utilising optimal model parameters, p. Advantageously, a set of parameters indicative of the image feature and constrained according to the shape model is produced according to the method 600, which may be output for further processing.

In an embodiment of the invention, information such as depth may be obtained from the determined parameters. The depth information can be obtained by calculating the horizontal disparity between the location of a point in the corresponding first and second image frames, thus allowing for calculation of a three-dimensional coordinate location of the point. It will be appreciated that the calculation of the three-dimensional coordinate location may be performed using any suitable 3D reconstruction technique.

In an embodiment of the invention, the 3D coordinate of the point may be used in further processing. For example, in embodiments where the depth information is indicative of a facial image feature, the coordinate may be used to drive the movement of a digital avatar or character which is then rendered to the user of a VR/AR system. The 3D coordinate positions may, for example, be streamed to an animation system in order to generate animation of the digital representation of the user. Advantageously, the method 400 allows for quick determination of parameters associated with the image feature such as depth, thereby providing an effective method for real-time calculation for use in VR/AR applications.

It will be appreciated that embodiments of the invention may comprise both a training method 100 and run-time method 400 together, or a training method 100 and run-time method 400 separately. Similarly, it will be appreciated that embodiments of the invention may comprise both a training system 500 and run-time system 600, or a training system 500 and run-time system 600 separately.

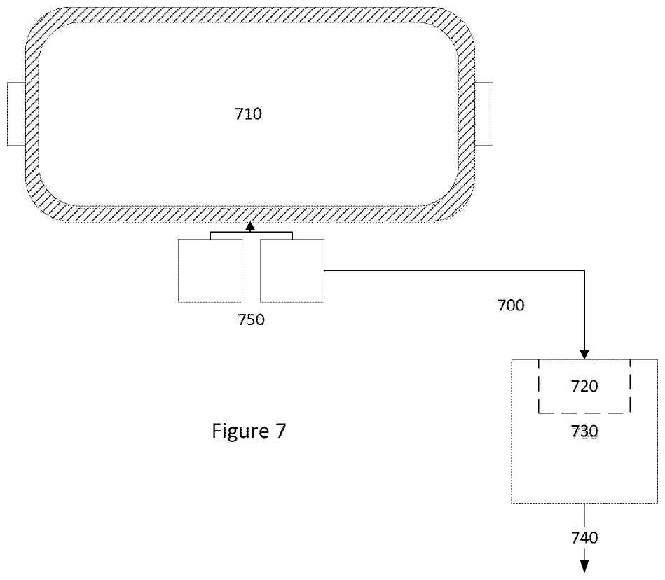

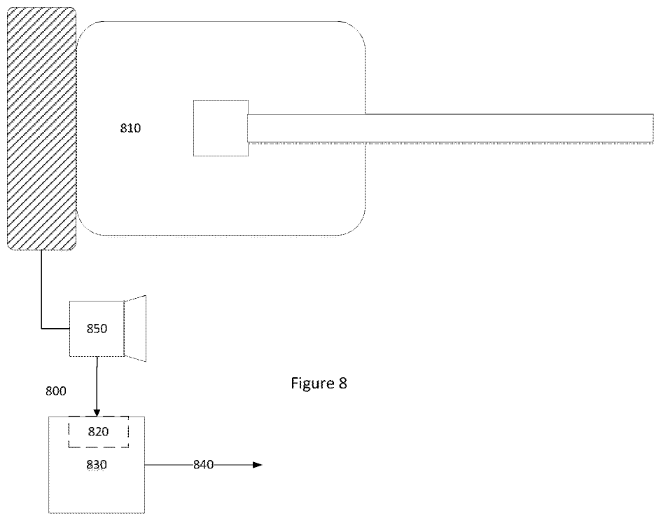

In an embodiment of the invention there is provided an apparatus 700 for determining facial features, as is shown in FIG. 7. The apparatus 700 may be associated with a run-time apparatus of the invention. In some embodiments, the apparatus 700 may be attachable to a VR/AR headset 710. In some embodiments, the apparatus 700 is integrated with a VR/AR headset 710. The apparatus 700 may be arranged to comprise an input means 720 for receiving stereo image data comprising a set of corresponding first and second stereo-rectified image frames indicative of a target, a processing means 730 for using a shape variation model to determine parameters associated with at least one image feature identified in the stereo image data, and an output means 740 for outputting the parameters associated with the at least one image feature. The apparatus 700 may be used to implement a method for determining facial features, as is illustrated in FIG. 6. The input means 710 for receiving stereo image data may comprise an interface for receiving data from a stereo camera, two (or more) individual or ordinary cameras mounted in a fixed positional relationship, such as side-by-side (which may include a predetermined spacing between the cameras), or any suitable image capture means 750 for providing stereo image data comprising a first and a second image frame of the target, such as at least a portion of a person's face.

FIG. 8 shows a side view of an apparatus 800 according to an example of the invention. The apparatus 800 may be associated with a run-time apparatus of the invention. In some embodiments, the apparatus 800 may be attachable to a VR/AR headset 810. In other embodiments, the apparatus 800 may be integrated with a VR/AR headset 810. The apparatus 800 may be arranged to comprise an input means 820 for receiving stereo image data comprising a set of corresponding first and second stereo-rectified image frames indicative of a target, a processing means 830 for using a shape variation model to determine parameters associated with at least one image feature identified in the stereo image data, and an output means 840 for outputting the parameters associated with the at least one image feature. The apparatus 800 may be used to implement a method for determining facial features, as is illustrated in FIG. 6. The input means 810 for receiving stereo image data may comprise an interface for receiving data from a stereo camera, two (or more) individual or ordinary cameras mounted in a fixed positional relationship, such as side-by-side (which may include a predetermined spacing between the cameras), or any suitable image capture means 850 for providing stereo image data comprising a first and a second image frame of the target, such as at least a portion of a person's face.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method of facial modelling, comprising:
receiving stereo image data comprising a set of corresponding first and second stereo-rectified image frames indicative of a target;
annotating the stereo image data to determine a location of an image feature in the first and second stereo-rectified image frames, wherein the determined locations in the first and second corresponding stereo-rectified image frames are positionally constrained according to an epipolar constraint; and
training a shape variation model corresponding to the target according to the determined image feature locations.

2. The method of claim 1, further comprising:
receiving stereo image test data comprising a set of first and second stereo-rectified image frames indicative of a target; and
processing the stereo image test data, wherein the processing comprises using the shape variation model to determine parameters associated with at least one image feature identified in the stereo image data.

3. The method of claim 1, wherein determining the location of an image feature comprises marking a first point location of the image feature in the first image frame and marking a second corresponding point location of the image feature in the second image frame.

4. The method of claim 1, wherein the shape variation model is trained to map a fixed vector of point locations, X, to a vector of model parameters, p, wherein the fixed vector of point locations, X, are indicative of the determined locations of the image feature.

5. (canceled)

6. A computer-implemented method of determining facial features, comprising:
receiving stereo image data comprising a set of corresponding first and second stereo-rectified image frames indicative of a target; and
processing the stereo image data, wherein the processing comprises using a shape variation model to determine parameters associated with at least one image feature, X, identified in the stereo image data.

7. (canceled)

8. The method of claim 6, wherein the processing comprises using the shape variation model to estimate a vector, p, of model parameters according to the identified image feature, X.

9. The method of claim 6, wherein determining parameters associated with the at least one image feature comprises using the shape variation model to estimate at least one point location, X′, indicative of the image feature, given the vector of model parameters p.

10. The method of claim 6, wherein the shape variation model is a Linear Point Distribution Model.

11. The method of claim 6, wherein the image features identified in the stereo image data correspond to image features determined for training the shape variation model.

12. The method of claim 6, wherein the features identified in the stereo image data are identified using a profile matching algorithm.

13. The method of claim 12, wherein the profile matching algorithm uses an Active Shape Model.

14. The method of claim 12, wherein the profile matching algorithm comprises tracking local patches in a regression framework.

15. A system for facial modelling, comprising:
input means for receiving stereo image data comprising a set of corresponding first and second stereo-rectified image frames indicative of a target;
annotating means for determining a location of an image feature in the first and second stereo-rectified image frames, wherein the determined locations in the first and second stereo-rectified image frames are positionally constrained according to an epipolar constraint; and
training means for training a shape variation model according to the determined image feature locations.

16. The system of claim 15, further comprising:
secondary input means for receiving stereo image data comprising a set of corresponding first and second stereo-rectified image frames indicative of a target; and
secondary processor for using the shape variation model to determine parameters associated with at least one image feature identified in the stereo image data; and
output means for outputting the parameters associated with the at least one image feature.

17. A system for determining facial features, comprising:
input means for receiving stereo image data comprising a set of corresponding first and second stereo-rectified image frames indicative of a target;
a processor for using a stored shape variation model to determine parameters associated with at least one image feature identified in the stereo image data; and
output means for outputting the parameters associated with the at least one image feature.

18. The system of claim 15, wherein the input means comprises a stereo camera; optionally the stereo camera attachable to a headset.

19. (canceled)

20. The system of claim 15, wherein the shape variation model is trained according to a training dataset which has been constrained according to an epipolar constraint.

21. (canceled)

22. (canceled)

23. The system of claim 15, wherein identifying the at least one image feature in the stereo image data comprises using a profile matching algorithm.

24. The system of claim 23, wherein the profile matching algorithm uses an Active Shape Model.

25. (canceled)

26. (canceled)

27. (canceled)

28. A non-transitory computer readable storage medium having instructions stored thereon, which when executed cause the computer to executed the computer-implemented method of claim 1.

29. A non-transitory computer readable storage medium having instructions stored thereon, which when executed cause the computer to executed the computer-implemented method of claim 6.
